(19) United States
(12) Patent Application Publication
(10) Pub. No.: US 2019/0030827 A1
(43) Pub. Date: Jan. 31, 2019

(54) ELASTIC ELECTRO-WELDING CONNECTION

(71) Applicant: Georg Fischer Wavin AG, Schaffhausen (CH)

(72) Inventor: Karl-Heinz Mayer, Singen (DE)

(21) Appl. No.: 16/043,215

(22) Filed: Jul. 24, 2018

(30) Foreign Application Priority Data
Jul. 26, 2017 (EP) 17 183 257.9

(51) Int. Cl. B29C 65/34; B29C 65/00; F16L 13/02

(52) U.S. Cl. CPC B29C 65/3424; B29L 2023/22; F16L 13/0236; B29C 66/522

(57) ABSTRACT

An electro-welding fitting includes a main body from a first plastics material having an elasticity modulus E2 and at least one heating element for heating the plastics first material. The at least one heating element is entirely or partially surrounded by a second plastics material that does not correspond to the first plastics material or that has other properties from those of the first plastics material

### CROSS REFERENCE TO RELATED APPLICATIONS

This application claims benefit to European Patent Application No. 17 183 257.9, filed Jul. 26, 2017.

### FIELD

The invention relates to an electro-welding fitting, in particular for connecting or hooking-up pipe ends from thermoplastic plastics material, containing a main body from thermoplastic or other welding-capable plastics materials and at least one heating element, preferably a heating wire coil having a plurality of windings for heating the plastics material.

### BACKGROUND

Electro-welding fittings for connecting or hooking-up pipeline parts from thermoplastic plastics materials are known. A heating element which is typically configured as a heating wire coil and which by way of the input of electrical energy generates a sufficient quantity of heat is disposed in the wall of the union so as to face the pipe, in order for the parts to be connected to be partially fused and welded.

In order for a good welded connection to be achieved, it is necessary in the case of conventional electro-welding fittings that the face to be welded is cleaned or peeled, respectively, in order for the outer, weathered surface to be removed. If no peeling of the pipe is performed, or said peeling is inadequate, the breaking behaviour of the welded connection is brittle by virtue of the high stress that is built up on account of the rather non-elastic plastics material, this arising not least because no materially integral bonding is possible between the material of the welding zone in the union and the pipe on account of the absent or inadequate peeling, since a materially integral bonding is only performed in the case of correct peeling in which the molecules are enabled to establish a materially integral connection in the welding zone of the union as well as in the pipe to be welded, said materially integral connection being equivalent to that of the basic material.

DE 196 28 916 A1 discloses a respective electro-welding fitting which is configured as a sleeve, and in which peeling of the pipe is required prior to welding. As has already been mentioned above, the disadvantage of this sleeve is that high stresses can be created by virtue of the plastics material in the welded connection, this in the case of inadequately peeled pipes then leading to breakages due to brittleness.

### SUMMARY

In an embodiment, the present invention provides an electro-welding fitting. The electro-welding fitting includes a main body from a first plastics material having an elasticity modulus E2 and at least one heating element for heating the first plastics material. The at least one heating element is entirely or partially surrounded by a second plastics material that does not correspond to the first plastics material or that has other properties from those of the first plastics material.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a longitudinal section through an electro-welding fitting which is configured as a sleeve, having a heating wire coil which is enclosed by a plastics-material hollow cylinder;

FIG. 2 shows a longitudinal section through an electro-welding fitting which is configured as a sleeve, having a heating wire coil which is partially enclosed by a plastics-material hollow cylinder;

FIG. 3 shows a longitudinal section through an electro-welding fitting which is configured as a sleeve, having a heating wire coil in which the wire is sheathed with another plastics material;

FIG. 4 shows a longitudinal section through an electro-welding fitting which is configured as a sleeve, having a heating wire coil which between the windings having another plastics material has windings without another plastics material;

FIG. 5 shows a longitudinal section through an electro-welding fitting which is configured as a union, having a heating wire coil which is enclosed by a plastics-material hollow cylinder;

FIG. 6 shows a longitudinal section through an electro-welding fitting which is configured as a saddle, having a heating wire coil which is enclosed by a plastics-material hollow cylinder; and

FIG. 7 shows a stress/elongation diagram with reference to the elasticity module of the plastics materials that are used in the welding zone.

### DETAILED DESCRIPTION

Embodiments of the invention provide electro-welding fittings which, without any peeling of the pipe, reduces the tension in the welding zone and are not subject to any breakage due to brittleness in the case of loads between the pipe and the welding.

According to embodiments of the invention, the heating element, preferably the heating wire coil, is entirely or partially surrounded by a plastics material that does not correspond to the plastics material of the main body, or is a plastics material different from that of the main body, respectively, or has other properties, in particular another elasticity modulus, respectively. This serves to avoid breakages due to brittleness in the welding between the electro-welding fitting and the pipe.

It is avoided on account thereof that a brittle breaking behaviour is created at the boundary surface of the pipe surface for fusing, this arising in most instances in the case of non-peeled pipes.

By arranging another plastics material, or a plastics material having other properties, respectively, in particular having another elasticity modulus, around the heating element, preferably the heating wire coil, the welding zone is enabled a certain degree of elasticity when external force influences arise. This is a great advantage for example in the case of flexural or tensile loads that arise on account of temperature variations or on account of compressions, since a high elongation is enabled around the heating element, or the heating wire coil, respectively, on account of the elastic region prior to the breaking stress being reached and a breakage arising, since such an elastic material by virtue of the higher elasticity thereof only very slowly builds up a high stress which leads to breakage.

One preferred embodiment lies in that the plastics material that surrounds the heating element, preferably the heating wire coil, has an elasticity modulus E1, wherein the elasticity modulus E1 of the plastics material that surrounds the heating element, preferably the heating wire coil, is smaller than the elasticity modulus E2 of the plastics material of the main body. On account of the elasticity modulus E1 being smaller than the elasticity modulus E2 of the main body, a lower stress is created in the welding, or in the boundary surface towards the pipe, respectively, since the seam is formed from another plastics material which is more resilient and elastic than the plastics material of the main body and, on account thereof, can be further elongated until the breakage arises, said breakage also taking place in the boundary region. This can be readily seen when the welding is overloaded in such a manner that said welding is subjected to a breakage, since said breakage in this instance is configured in a ductile manner and thus, prior to the connection failing, is first imparted a substantial deformation.

It is advantageous for the elasticity modulus E1 of the plastics material that surrounds the heating element, preferably the heating wire coil, to be smaller than or equal to 50% of the elasticity modulus E2 of the plastics material of the main body. On account thereof, the stress is reduced at the same loads.

A heating wire coil is preferably to be used as the heating element, a conducting plastics material that can be used as a heating element however also being conceivable. Other heating elements that can be attached to or in the union such as conducting tapes, conducting bushes, et cetera, are also conceivable.

The electro-welding fitting has a main body which is preferably configured as a sleeve, union, or saddle. When the main body is configured as a sleeve, said main body serves for connecting two pipe ends in that the pipe ends are push-fitted into the sleeve, the external diameter of the pipes bearing on the internal diameter of the sleeve, and said pipe ends being welded to said sleeve.

In the case of a union being the main body, the pipe ends are push-fitted onto the union, or the internal diameter of the pipe ends bears on the external diameter of the union, respectively, said ends and said union then being welded together.

As a further potential embodiment, there is the configuration of the main body as a saddle. The latter is placed onto a pipe and enables a branching pipe to be connected thereto.

According to one preferred embodiment, the main body is produced from polypropylene (PP), polybutylene (PB), polyvinylchloride (PVC), polyvinylidene fluoride (PVDF), or polyethylene (PE).

It is advantageous for the plastics material that entirely or partially surrounds the heating wire coil to be a thermoplastic elastomer (TPE), a polyethylene (PE), a low density polyethylene (LDPE), a mixed polyethylene (mixed PE), or a foamed polyethylene (PE). These plastics materials have an elasticity modulus E1 which is below the elasticity modulus E2, preferably is equal to or smaller than 50% of the elasticity modulus E2 of the main body.

A further design embodiment of the invention lies in that the heating wire coil is disposed in a hollow cylinder from plastics material having the elasticity modulus E1, or in the wall of said hollow cylinder, respectively. The hollow cylinder is disposed on that circumference of the main body that is in contact with the pipe, that is to say on the internal circumference in the case of a sleeve, on the external circumference in the case of a union, and on the internal circumference of the saddle piece in the case of a saddle.

Is a further potential design, the wire of the heating wire coil can be sheathed with plastics material having the elasticity modulus E1, and said wire can then be placed into the main body.

It is also advantageous for not all windings of the heating wire coil to be surrounded by the plastics material having the elasticity modulus E1, that is to say for only a couple of the windings of the heating wire coil to be surrounded with the plastics material having the elasticity modulus E1, and for the others to be surrounded with the plastics material of the main body, having the elasticity modulus E2. Besides the advantage of elasticity in welding, this in the region of the plastics material having the elasticity modulus E2 also offers the advantage that a high axial tensile force can be absorbed.

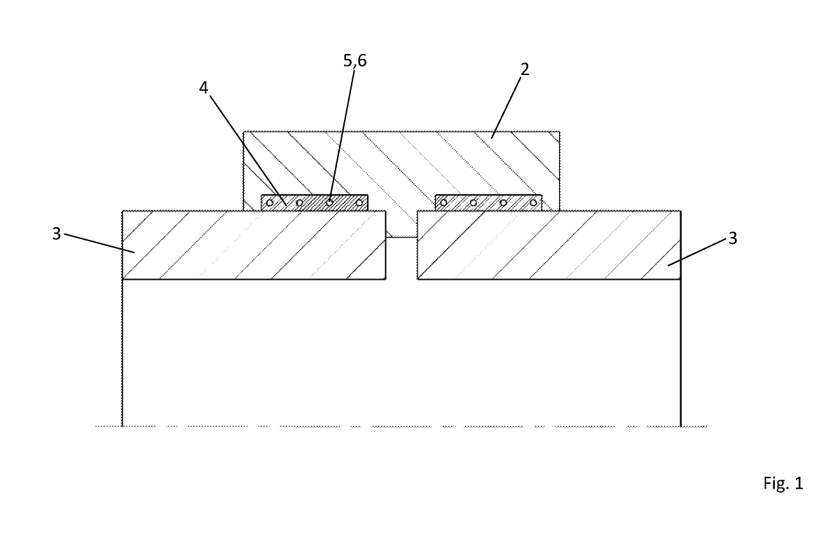

The drawing illustrated in FIG. 1 shows an electro-welding fitting 1 which as a main body 2 has a sleeve. The sleeve on the internal circumference thereof has a heating wire coil 5 which serves for heating the plastics material and thus for welding the main body 2 to the pipe ends 3. The heating wire coil 5 is surrounded by a plastics material 4 different from that used in the configuration of the main body 2, or is surrounded by a plastics material which has properties different from the plastics material of the main body 2, respectively. The plastics material 4 around the heating wire coil 5 has an elasticity modulus E1 lower than that of the main body 2. In the embodiment illustrated in FIG. 1, the heating wire coil 5 is disposed in a hollow cylinder that is formed from a different kind of plastics material 4, or is disposed in the wall of said hollow cylinder. On account thereof, the more elastic plastics material 4 which surrounds the heating wire coil is heated on the one hand, as well as the plastics material of the pipes, this then enabling the welding. The use of the more elastic plastics material 4 reduces the stress that arises in the welding, or in the boundary surface towards the pipe, respectively, thus not leading to a breakage on account of brittleness between the weld seam and the welded pipe in the case of a failure of the welding. On account of the more elastic plastics material 4 in the welding zone, said plastics material 4 in the case of external influences arising, can better yield, or is elongated more, and on account thereof less rapidly builds up a high stress, respectively, or less rapidly reaches the breakage stress at which the material fails, respectively.

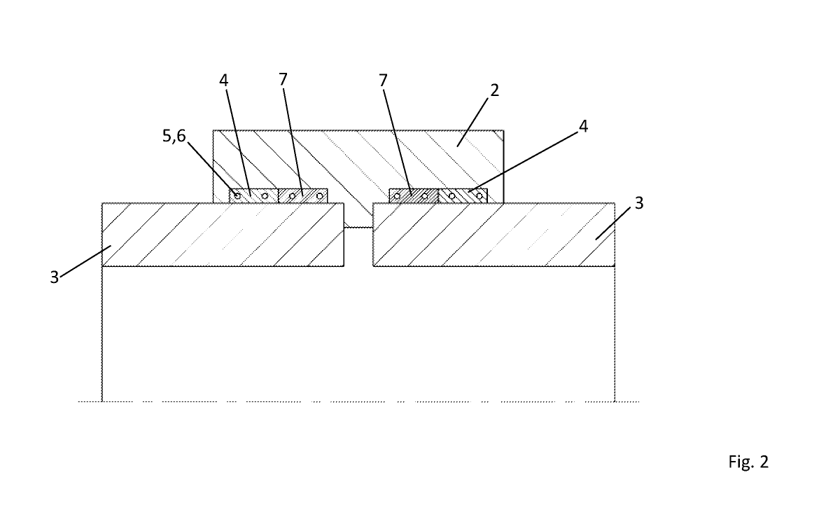

The embodiment of the electro-welding fitting 1 depicted in FIG. 2 shows the heating wire coil 5 which is only partially surrounded by the more elastic, or different, respectively, plastics material 4, only a couple of the windings 6 of said heating wire coil 5 being surrounded by said plastics material 4, and the other windings 6 being surrounded by the plastics material 7 of the main body 2, respectively. This has the advantage, on the one hand, that the more elastic region having the plastics material 4 having the lesser elasticity modulus E1 is subjected to lower stresses, the other region of the heating wire coil 5 which is surrounded by the plastics material 7 of the main body 2, being advantageous in terms of high axial tensile forces.

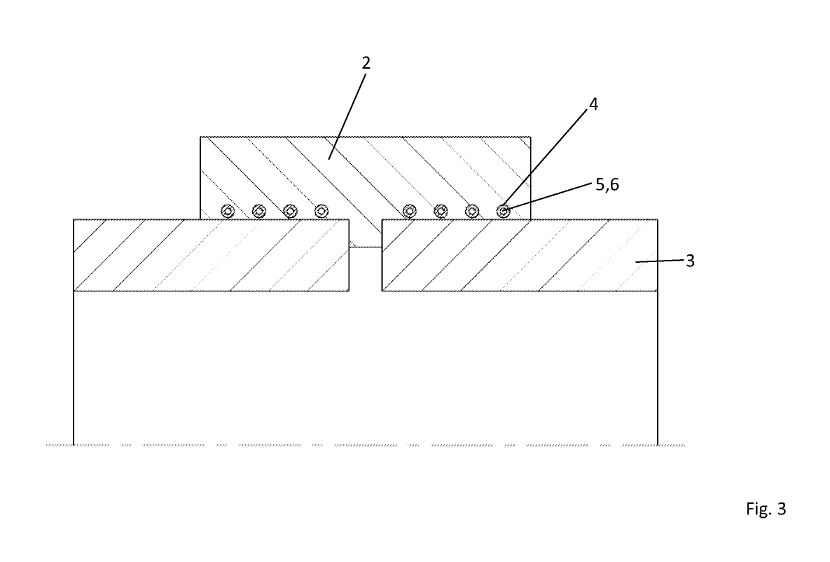

A further alternative arrangement of the more elastic plastic material having the elasticity modulus E1 is shown in FIG. 3, in which the more elastic plastics material 4 is disposed around the coil wire of the heating wire coil 5, or the wire is coated with the plastics material, and said wire is then disposed in the main body 2 which in FIG. 3 is configured as a sleeve, but can also be configured as a union or saddle.

All potential arrangements and design embodiments shown can be applied to all main bodies 2, whether a sleeve, a union, or else a saddle.

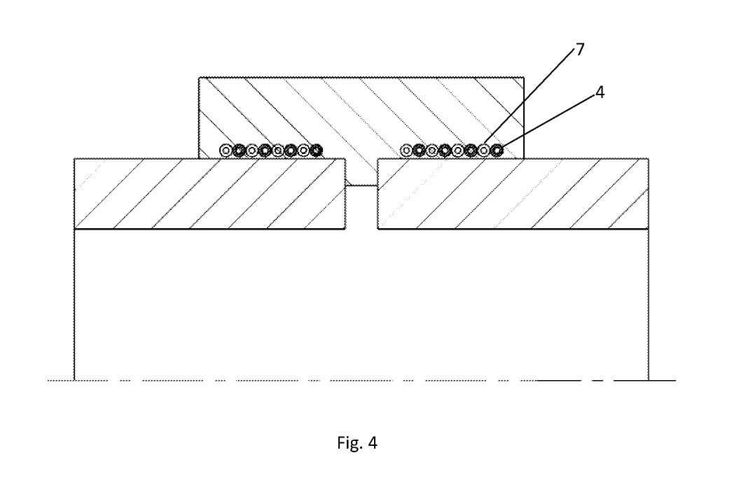

FIG. 4 shows the potential in the design in which a further coil which in this instance is surrounded directly by the plastics material 7 of the main body 2 is disposed between the individual windings 6 of the heating wire coil 5 which is surrounded by a different plastics material 4.

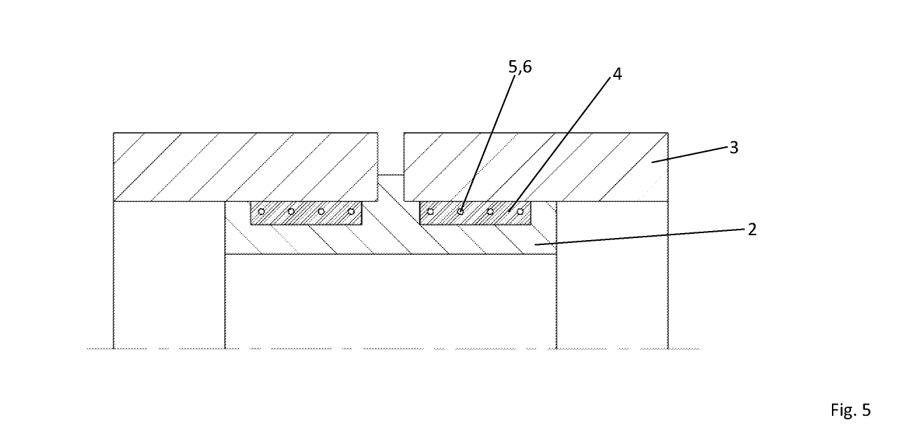

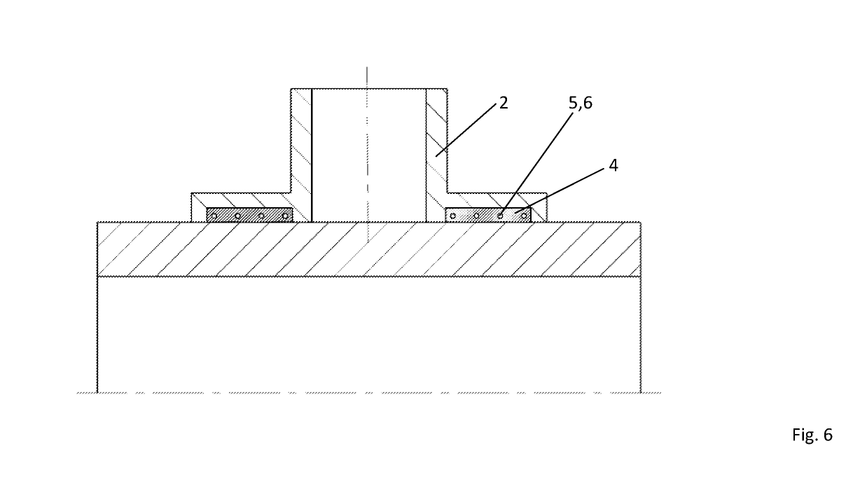

FIG. 5 shows the potential of arranging the heating wire coil 5, as is illustrated in FIG. 1, in a hollow cylinder from the elastic plastics material 4 having the elasticity modulus E1 on a union as the main body 2. A saddle which likewise has this arrangement of the heating wire coil 5 is shown in an analogous manner in FIG. 6.

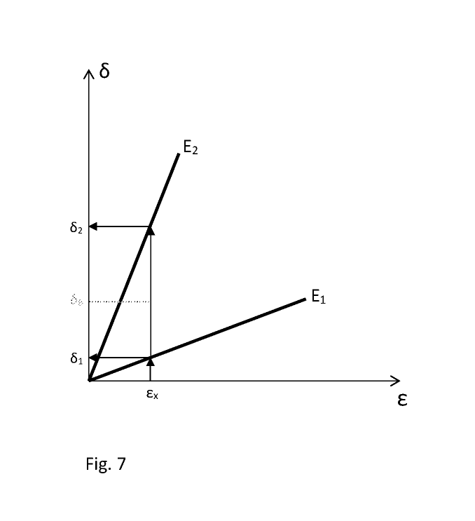

FIG. 7 shows the stress/elongation diagram with reference to the elasticity module of the welding having the dissimilar plastics materials 4, 7. E1 shows the elasticity modulus of the plastics material 4 different from the plastics material from which the main body is configured, said plastics material 4 being preferably configured so as to be more elastic. E2 shows the elasticity modulus of the plastics material 7 of the main body 2. Ex is the elongation applied by virtue of external loads, either by compression or acting forces otherwise applied. It can be clearly seen that in the use of the more elastic plastics material 4 having the elasticity modulus E1 in the welding zone, the tension curve runs lower as compared to a welding having the plastics material 7 of the main body 2, having the higher elasticity modulus E2 in the welding zone, the latter being the prior art. The higher elasticity of the plastics material 4 having the lesser elasticity modulus E1 in the case of forces arising builds up less stress, that is to say that in order for the breaking stress to be attained, a significantly higher elongation is required until the breakage finally arises.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Electro-welding fitting

2 Main body

3 Pipe end

4 Plastics material different from that of the main body (having the elasticity modulus E1)

5 Heating wire coil

6 Winding

7 Plastics material same as that of the main body

δ Stress [N/mm²]

δ₁ Stress in the boundary surface in the welding zone having plastics material different from that of the main body [N/mm²]

δ₂ Stress in the boundary surface in the welding zone having plastics material same as that of the main body [N/mm²]

δ_{B} Breaking stress [N/mm²]

E1 Elasticity modulus of the plastics material surrounding the heating wire coil (plastics material different from that of the main body)

E2 Elasticity modulus of the main body plastics material

ϵ Elongation [%]

ϵₓ Elongation applied by virtue of external loads

What is claimed is:

1. An electro-welding fitting, comprising:
a main body from a first plastics material having an elasticity modulus E2; and
at least one heating element for heating the first plastics material,
wherein the at least one heating element is entirely or partially surrounded by a second plastics material that does not correspond to the first plastics material or that has other properties from those of the first plastics material.

2. The electro-welding fitting according to claim 1, wherein the second plastics material has an elasticity modulus E1, wherein the elasticity modulus E1 of the second plastics material is smaller than the elasticity modulus E2 of the first plastics material.

3. The electro-welding fitting according to claim 1, wherein the elasticity modulus E1 of the second plastics material is smaller than or equal to 50% of the elasticity modulus E2 of the first plastics material.

4. The electro-welding fitting according to claims 1, wherein the main body is configured as a sleeve, union, or saddle.

5. The electro-welding fitting according to claim 1, wherein the main body is produced from PP, PB, PVC, PVDF, or PE.

6. The electro-welding fitting according to claim 1, wherein the second plastics material is a TPE, PE, LDPE, a mixed PE or a foamed PE.

7. The electro-welding fitting according to claim 1, wherein the heating element is disposed in a hollow cylinder, or in the wall of the latter, respectively, from the second plastics material.

8. The electro-welding fitting according to claim 10, wherein the wire of the heating wire coil is sheathed with the second plastics material.

9. The electro-welding fitting according to claim 10, wherein not all windings of the heating wire coil are surrounded by the second plastics material.

10. The electro-welding fitting according to claim 1, wherein the heating element is a heating wire coil having a plurality of windings.

11. The electro-welding fitting according to claim 1, wherein the first plastics material is a thermoplastic.
